(19) United States
(12) Patent Application Publication
(10) Pub. No.: US 2026/0057178 A1
(43) Pub. Date: Feb. 26, 2026

(54) SYSTEM AND METHOD FOR LEASE ABSTRACTION

(71) Applicant: Accenture Global Solutions Limited, Dublin (IE)

(72) Inventors: Abhishek SINGH, Deoghar (IN); Swati TATA, Bangalore (IN); Ranjan SARMAH, Guwahati (IN); Bhargav KOVI, Tirupati (IN); Sangeetha K B, Bangalore (IN); Lakshmi RAMANATHAN, Bangalore (IN)

(21) Appl. No.: 18/815,040

(22) Filed: Aug. 26, 2024

(51) Int. Cl. G06F 40/289; G06F 40/30; G06Q 30/0645

(52) U.S. Cl. CPC G06F 40/289; G06F 40/30; G06Q 30/0645

(57) ABSTRACT

System and method for lease abstraction from a lease document is disclosed. The method includes, receiving the lease document and requirements for processing the lease document, and processing the lease document into vector chunks. Processing the lease document includes, parsing the lease document into text and separating the text into non-overlapping logical areas, applying predetermined chunk rules to the separated text to generate chunks, and converting the chunks into vectors chunks. The method further includes, generating a process flow for each of the requirements, the process flow defining entities to be considered for analyzing the lease document and criteria for analyzing the lease document, and for each of the requirements, applying the corresponding generated process flow to the vector chunks of the lease document, wherein the applying provides information from the lease document responsive to the requirements regardless of format and content of the lease document.

### FIELD OF THE INVENTION

The present disclosure generally relates to the field data analysis and more particularly to system and method for lease abstraction.

### BACKGROUND

Lease abstraction is a process of extraction and summarization of key information and terms from a lease agreement into a concise document or a database. The abstraction is generally done by an analyst to provide a clear understanding of the rights, responsibilities and obligations both the parties, lessor and lessee, involved in the lease. The lease abstraction includes extraction and summarization of information including but not limited to basic information, financial terms and conditions, property or product or service description, information related to termination and renewal, provisions, rights and obligations, and legal and compliance information. As the lease agreement includes vast amounts of information and complex legal language, the abstraction provides summarized points that are easier to access, review and understand, and streamlines the operations, improves transparency and mitigates risks associated with the lease agreement.

### SUMMARY

This summary is provided to introduce a selection of concepts in a simple manner that is further described in the detailed description of the disclosure. This summary is not intended to identify key or essential inventive concepts of the subject matter nor is it intended for determining the scope of the disclosure.

A method for abstracting a lease document is disclosed. The method includes, receiving a lease document and requirements for processing the lease document, processing the lease document into vector chunks, comprising, parsing the lease document into text, separating the text into non-overlapping logical areas, applying predetermined chunk rules to the separated text to generate chunks, and converting the chunks into vectors chunks. Further, the method includes, generating a process flow for each of the requirements, the process flow defining entities to be considered for analyzing the lease document and criteria for analyzing the lease document, and for each of the requirements, applying the corresponding generated process flow to the vector chunks of the lease document, wherein the applying provides information from the lease document responsive to the requirements regardless of format and content of the lease document.

Further disclosed is a system for abstracting a lease document. The system includes a processor and a non-transitory computer readable media storing instructions programmed to cooperate with the processor to perform operations including receiving a lease document and requirements for processing the lease document, and processing the lease document into vector chunks, wherein processing includes, parsing the lease document into text, separating the text into non-overlapping logical areas, applying predetermined chunk rules to the separated text to generate chunks and converting the chunks into vectors chunks. The processor is further configured for generating a process flow for each of the requirements, the process flow defining entities to be considered for analyzing the lease document and criteria for analyzing the lease document, and for each of the requirements, applying the corresponding generated process flow to the vector chunks of the lease document, wherein the applying provides information from the lease document responsive to the requirements regardless of format and content of the lease document.

It is appreciated that methods in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

Various embodiments in accordance with the present disclosure will be described with reference to the drawings, in which:

FIG. 1 depicts an example environment 100 that can be used to execute implementations of the present disclosure;

FIG. 2 depicts a block diagram of the system for abstracting a lease document, in accordance with an embodiment of the present disclosure;

FIG. 3 depicts process flow generation, in accordance with an embodiment of the present disclosure;

FIG. 4 depicts a local group skip connection-based node-link Seq2Seq module, in accordance with an embodiment of the present disclosure;

FIG. 5 depicts a flowchart illustrating a method of abstracting a lease document, in accordance with an embodiment of the present disclosure; and

FIG. 6 illustrates a schematic diagram of an exemplary generic classical processor system.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” herein (e.g., “for example,” “an example of,” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

As described in the background, lease abstraction is a process of extraction and summarization of key information and terms from a lease agreement into a concise document or a database. The abstraction is generally done by an analyst to provide a clear understanding of the rights, responsibilities and obligations both the parties, lessor and lessee, involved in the lease. The lease abstraction includes extraction and summarization of information including but not limited to basic information, financial terms and conditions, property or product or service description, information related to termination and renewal, provisions, rights and obligations, and legal and compliance information.

During the abstraction process, the analyst downloads the lease documents from the sources, identifies the type of the lease documents, performs completeness check and translation if required. Further, the analyst reads through the lease documents to identify the key terms and to prepare the summary of the lease agreement. Since the lease documents often include multiple pages with hundreds of fields, entities, images, tables, etc., the manual process requires significant human effort, the process is labor intensive, and time-consuming. Furthermore, the quality of the summary depends on the analysts performing the abstraction process. For example, different analysts may interpret and prioritize the information differently, leading to variations in the quality and consistency of the summary, affecting the accuracy and reliability of the produced summary. Further, the analysts may misinterpret the terms in the lease agreements, and inadvertently omit important clauses and entities while summarizing the lease agreements.

Further, the lease agreements often will be in different formats and include different substantive components and use different terms for similar concepts and entities. Few artificial intelligence (AI) models developed can abstract a lease document of a specific format. However, such models fail to abstract any given lease document irrespective of the format of the given lease document.

To address the one or more limitations, embodiments of the present disclosure disclose a system and a method for lease abstraction, specifically for abstracting lease documents of any given format, that is, regardless of the format or content of the specific lease agreement/document. The term lease document or lease agreement as described herein refers to a legally binding contract between a lessor and a lessee that outlines the terms and conditions under which a property or a product or a service is rented or leased. The lease document specifies the rights and the responsibilities of both the parties regarding the use of the property or the product or the service that is rented or leased. The lease document may include various entities including but not limited to parties involved, terms of lease including but not limited to start date, expiry date, renewal date, expiry and renewal terms, etc., rent and payment terms, deposits, utilities and services, termination and renewal, etc.

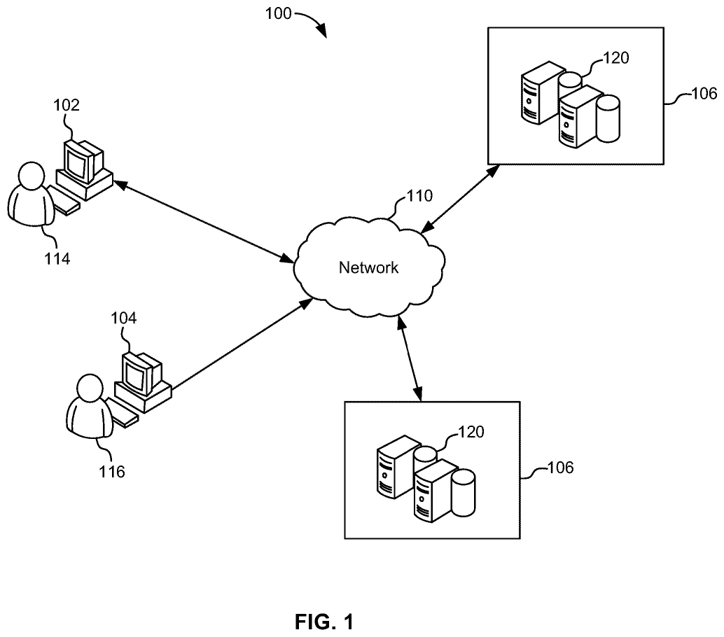

FIG. 1 depicts an example environment 100 that can be used to execute implementations of the present disclosure. In some examples, the example environment 100 enables users associated with respective systems to execute requests to abstract a lease document by invoking one or more trained models in accordance with implementations of the present disclosure. The example environment 100 includes computing devices 102 and 104, back-end systems 106, and a network 110. In some examples, the computing devices 102 and 104 are used by respective users 114 and 116 to log into and interact with the platforms and running applications according to implementations of the present disclosure.

In the depicted example, the computing devices 102 and 104 are depicted as desktop computing devices. It is contemplated, however, that implementations of the present disclosure can be realized with any appropriate type of computing device (e.g., smartphone, tablet, laptop computer, voice-enabled devices). In some examples, the network 110 includes a local area network (LAN), wide area network (WAN), the Internet, or a combination thereof, and connects web sites, user devices (e.g., computing devices 102, 104), and back-end systems (e.g., the back-end systems 106). In some examples, the network 110 may include a wired and/or a wireless communications link. For example, mobile computing devices, such as smartphones can utilize a cellular network to access the network 110.

In the depicted example, the back-end systems 106 each include at least one server system 120. In some examples, the at least one server system 120 hosts one or more computer implemented services that users can interact with by using computing devices 102 and 104. For example, components of enterprise systems and applications can be hosted on one or more of the back-end systems 106. In some examples, a back-end system can be provided as an on-premises system that is operated by an enterprise or a third-party taking part in cross-platform interactions and data management. In some examples, a back-end system can be provided as an off-premises system (e.g., cloud or on-demand) that is operated by an enterprise or a third-party on behalf of an enterprise.

In some examples, the computing devices 102 and 104 each include computer-executable applications executed thereon. In some examples, the computing devices 102 and 104 each include a web browser application executed thereon, which can be used to display one or more web pages of platform running applications. In some examples, each of the computing devices 102 and 104 can display one or more GUIs that enable the respective users 114 and 116 to interact with the computing platform. In accordance with implementations of the present disclosure, the back-end systems 106 may host enterprise applications or systems that require data sharing and data privacy. In some examples, the computing device 102 and/or the computing device 104 can communicate with the back-end systems 106 over the network 110.

In some implementations, at least one of the back-end systems 106 can be implemented in a cloud environment that includes at least one server system 120. In the example of FIG. 1, the back-end server 106 can represent various forms of servers including, but not limited to, a web server, an application server, a proxy server, a network server, and/or a server pool. In general, server systems accept requests for application services and provide such services to any number of client devices (for example, the computing device 102 over the network 110).

In one embodiment of the present disclosure, the system for abstracting a lease document is implemented with the back-end system 106 and a user may use the computing devices 102 and 104 for providing input to the system, the input including at least the lease document and the requirements for processing the lease document.

Embodiments of the present disclosure relate to a system and a method for abstracting a lease document of any given format, that is, regardless of the format or content of the specific lease document. In one embodiment, upon receiving the lease document and the requirements for processing the lease document, the system processes the lease document to generate vector chunks. Then the system generates a process flow for each of the requirements, the process flow defining entities to be considered for analyzing the lease document and criteria for analyzing the lease document. Then for each of the requirements, the system applies the corresponding generated process flow to the vector chunks of the lease document and fetches information from the lease document responsive to the requirements regardless of format and content of the lease document. The manner in which the lease document is abstracted to provide summarized points that are easier to access, review and understand is disclosed below in further detail.

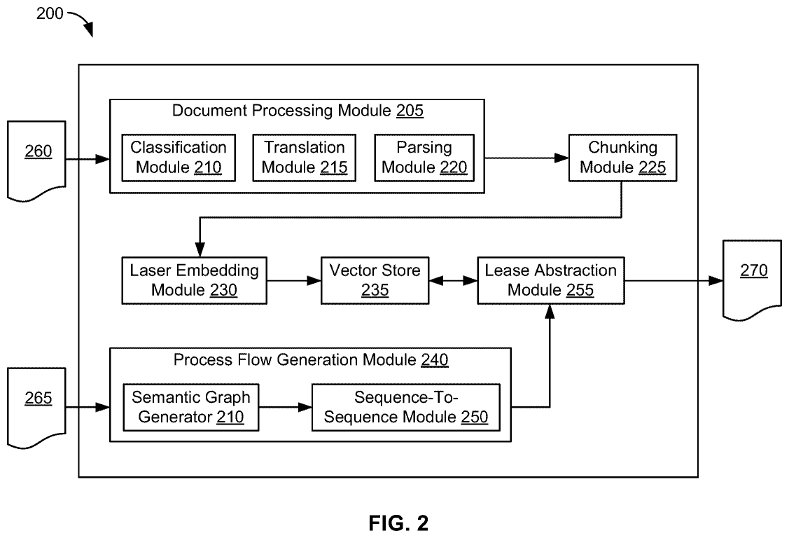

FIG. 2 depicts a block diagram of the system for abstracting a lease document, in accordance with an embodiment of the present disclosure. As shown, the system 200 includes a document processing module 205 including a classification module 210, a translation module 215 and a parsing module 220, a chunking module 225, a Language-Agnostic SEntence Representation (LASER) embedding module 230, a vector store 235, a process flow generation module 240 including a semantic graph generator 245 and a Sequence-to-Sequence module 250 (hereafter referred to as Seq2Seq module), and a lease abstraction module 255. It is to be noted that the system 100 may include, for example, a mainframe computer, a computer server or a network of computers with big data processing capabilities. Accordingly, the system 200 includes one or more processors associated processing modules, interfaces and storage devices communicatively interconnected to one another through one or more communication means. The storage associated with the system 200 may include volatile and non-volatile memory devices for storing information and instructions to be executed by the one or more processors and for storing temporary variables or other intermediate information during processing.

As described, the system 200 is configured abstracting a lease document of any given format. The lease document or lease agreement refers to a legally binding contract between a lessor and a lessee that outlines the terms and conditions under which a property or a product or a service is rented or leased. The lease document specifies the rights and the responsibilities of both the parties regarding the use of the property or the product or the service that is rented or leased. The lease document may include various entities including but not limited to parties involved, terms of lease including but not limited to start date, expiry date, renewal date, expiry and renewal terms, etc., rent and payment terms, deposits, utilities and services, termination and renewal, etc. Hence, the input to the system 200 is a lease document 260 and requirements 265 for processing the lease document 260. The lease document 260 and the requirements 265 may be inputted to the system 200 through an interface of the system 200 or through an interface of the computing devices 102 and 104. Further, the lease document 260 and the requirements 265 may be in any known format such as but not limited to PDF, word, text file, etc. The requirements 265 may include but not limited to business entities to be extracted from the lease document 260, general entities to be analyzed in the lease document 260 such as start date, renewal date, expiry date, terms and conditions, etc., search keywords, type of expected output (characters, integer, float, etc.) of different entities, or text defining the content to be extracted from the lease document 260. In general, the requirements 265 include but not limited to text defining the information to be extracted from the lease document. The requirements 265 may be defined and provided in a file or may be inputted to the system 200 using a dedicated interface or platform. It is to be noted that the term lease document refers to a single document or a collection of documents which may include a lease document and other documents related to the lease document. In one embodiment, upon receiving a lease document 260 and requirements 265 for processing the lease document, the document processing module 205 processes the lease document 260. The processing may include but not limited to Optical Character Recognition (OCR) to covert the content in the lease document 260 into machine readable text, classification of the document by the classification module 210, language translation by the translation module 215 and parsing by the parsing module 220. In one embodiment, the classification module 215 uses a trained convolution neural network (CNN) model for classifying the received lease document 260 into one of a lease document, amendment document, renewal document, termination document, extension document, etc. Then language translation is performed, if required, and then the lease document 260 is parsed using the parsing module 220. The parsing by the parsing module 220 may include but not limited to removal of redundant information, error correction, etc. In one embodiment of the present disclosure, the parsing module 220 is further configured for separating the text of the lease document 260 into non-overlapping logical areas. For example, the parsing module 220 is configured to extracts the text from the document, identify paragraphs, columns, tables, floating images, headers and footers, sections, subsections, etc. Upon identification, the parsing module 220 removes the images and tables to generate an optimal flow of text for further processing. It is to be noted that the document containing the requirements 265 may also be parsed using the parsing module 220.

Upon parsing, the chunking module 225 applies predetermined chunk rules to the separated text to generate chunks. In one embodiment of the present disclosure, a custom natural language processing (NLP) model is used for chunking the lease document 260. Chunking includes splitting the text into phrases or segments such as noun phrases, verb phrases or other grammatical structures. In one embodiment, upon separating the text of the lease document 260 into non-overlapping logical areas, the chunking module 225 breaks the text into words or tokens, and then applies one or more chunking rules for generating the chunks of the lease document 260. The one or more chunking rules may include but not limited to noun phrase rule, verb phrase rule, preposition phrase rule, or any other custom rules. The plurality of generated chunks of the lease document 260 is fed to the laser embedding module 230.

In one embodiment of the present disclosure, the LASER embedding module 230 converts the generated chunks of the lease document 260 into vector chunks. That is, the LASER embedding module 230 uses a pretrained language-agnostic sentence representation (LASER) model, trained on a large corpus of text, to encode the text chunks into embeddings. The embeddings are the numerical representations of the text chunks that capture the meaning of the chunks. Each vector represents the meaning of the text chunk in a multi-dimensional space and the dimensions of the vector capture various semantic and syntactic aspects of the text of the lease document 260. The generates vector chunks are stored in the vector store 235.

As described, the input to the system 200 is the lease document 260 and the requirements 265 for processing the lease document 260. In one embodiment of the present disclosure, upon receiving the requirements 265, the process flow generation module 240 generates a process flow for each of the requirements, wherein the process flow defines entities to be considered for analyzing the lease document 260 and criteria for analyzing the lease document 260. As described, the requirements 265 may include but not limited to business entities to be extracted from the lease document 260, general entities to be analyzed in the lease document 260 such as start date, renewal date, expiry date, terms and conditions, etc., search keywords, type of expected output (characters, integer, float, etc.) of different entities, or text defining the content to be extracted from the lease document 260. In general, the requirements 265 include but not limited to text defining the information to be extracted from the lease document. On receiving one or more requirements, the process flow generation module 240 generates a process flow for each requirement and the generated process flow includes the entities to be considered for analyzing the lease document 260 and criteria defining how to extract the information from the lease document 260. For example, considering the lease expiration data as the requirement from a user, the process flow generation module 240 generates a process flow, wherein the process flow includes entities such as expiration date, end date, termination date, etc., for analyzing the lease document 260.

In one embodiment of the present disclosure, the process flow generation module 240 utilizes the semantic graph generator 245 and the Seq2Seq module 250 for generating the process flow for each requirement. The semantic graph generator 245 initially creates a semantic graph using entities present in a requirement and then converges the created semantic graph with a pre-created semantic graph for identifying the entities to be considered for analyzing the lease document 260. Then the Seq2Seq module 250 generates the process flow for each requirement using the entities to be considered for analyzing the lease document and pretrained process flows.

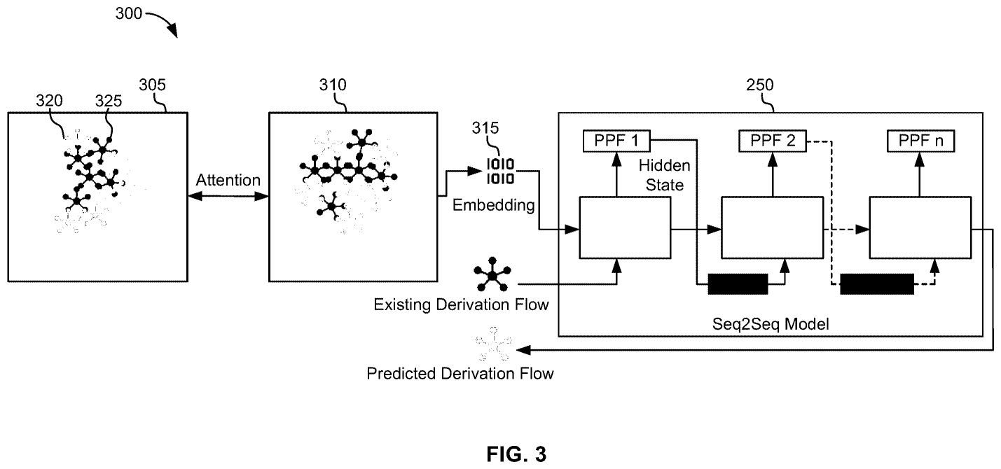

FIG. 3 depicts process flow generation, in accordance with an embodiment of the present disclosure. In one embodiment, the entities present in the requirements 265 are identified using natural language processing (NLP) techniques. Alternatively, the entities are identified using pretrained named entity recognition (NER) models, transformers, deep learning models, etc. Then the sematic graph is generated using the entities extracted from the requirements 265. In the graph, each node represents an entity, and the edge connected the nodes represents the relationship between the entities. Referring to FIG. 3, the nodes and edges highlighted in grey color 320 represents the sematic graph generated based on the entities present in the requirements 265. Further, the nodes and the edges highlighted in black color 325 represents the pre-created sematic graph. In one embodiment of the present the pre-created sematic graph is created using the entities of historical analysis of a plurality of lease documents or domain knowledge or combination of the historical analysis and the domain knowledge.

In one embodiment of the present disclosure, the created semantic graph is fused or converged with the pre-created semantic graph, with semi-supervised semantic graph confluence with contrastive loss, for identifying the entities to be considered for analyzing the lease document.

Referring to FIG. 3, the graph 305 depicts confluence of the created semantic graph and the pre-created semantic graph, and the graph 310 depicts an output of the confluence as a result of contrastive loss. The confluence brings similar entities together while dispersing out entities that differ from each other. Hence, the semantic graph generator 245 brings the similar entities closer and hence identifies the entities to be considered for analyzing the lease document 260. For example, the entities such as lease start date, begin date, end date, termination date, etc. will come closer to each other on the graph. However, the entities such as the start data and the begin date will be closer as compared to start date with the end date or the termination date. The process enhances the feature representation of each new entity and brings optimal information to the next stage. In one embodiment of the present disclosure, upon identifying the entities (the nodes) to be considered for analyzing the lease document, embedding 315 is generated for the nodes. The embedding 315 is then fed to the Seq2Seq module 250.

Considering G₁ as the pre-created semantic graph with n entities and m features and G₂ as the created semantic graph with n′ entities and m′ features, the two semantic graphs are created based on intra-entity feature similarity between nodes within the respective semantic graphs. Then the contrastive loss on the entities using their features is computed as below:

$$\{ \begin{matrix}{‖ {x}_{i} - {x}_{j} ‖}^{2} if ‖ {x}_{i} - {x}_{j} ‖ < margin \\ max ( 0 , margin - {‖ {x}_{i} - {x}_{j} ‖}^{2} ) otherwise\end{matrix} for {x}_{{i}_{i = 1}^{n}} ∈ {G}_{1} and {x}_{{j}_{j = 1}^{{n}^{′}}} ∈ {G}_{2}$$

The contrastive loss function helps creating an optimal confluence between individual nodes of the sematic graph G₂ and pre-created sematic graph G₁. Then for each xᵢ∈G₁ and xⱼ∈G₂ embedding eᵢ and eⱼ obtained respectively using attention network. The eᵢ and eⱼ will contain feature diffusion from intra-nodes and inter-nodes neighbors and optimal neighbors are selected using contrastive loss. In one embodiment, aggregated loss across all attention heads is computed using embedding eᵢ and [symbol] from created and pre-trained semantic graphs G₂ and G₁. The aggregated loss further refines the entity embedding for the created semantic graph G₂.

Referring to FIG. 3, the input to the Seq2Seq module 250 is the embedding 315 of the entities and one or more pretrained process flows 320. Each of the one or more pretrained process flows trained using domain knowledge to provide a structured approach to understand the context and to generate the summary from the lease documents. Examples of pretrained process flows include but not limited to, [“Word to number”, “MMM to Month”, “Date extraction”, “Number of days till date”], [“Word to number”, “MMM to Month”, “Date extraction”, “Max”, “Transform to DD-Mon-YYYY”] and [“Replace punctuation”, “MMM to Month”, “Word to number”, “Date extraction”, “Transform to DD-Mon-YYYY”].

In one embodiment of the present disclosure, skip connection-based neighborhood embedding is given as an input to the Seq2Seq module 250. That is, instead of feeding single node's embedding to the Seq2Seq module 250, skip connection-based neighborhood embedding is given as an input to the Seq2Seq module 250. Encoder of the Seq2Seq module 250 processes the entities (embedding 315) and the pretrained process flow and decoder generates the new process flow for extracting the information from the lease document 260. In one embodiment of the present disclosure, Node-Link Seq2Seq model is used for generating the process flow for each requirements using the entities to be considered for analyzing the lease document and the pretrained process flows. The Node-Link Seq2Seq model combines the principle of graph representation with eq2seq architecture.

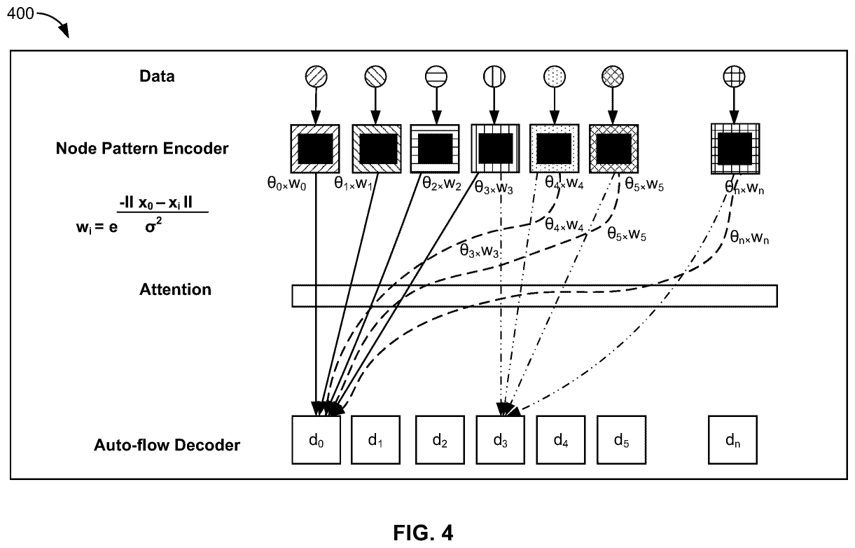

FIG. 4 depicts a local group skip connection-based node-link Seq2Seq module, in accordance with an embodiment of the present disclosure. As shown, the input to the module are the entities (nodes), and the node pattern encoder processes the input to create latent representation. The attention mechanism allows the module to focus on specific nodes while generating the output. Unlike traditional approaches where only the final hidden state of the encoder is relayed to the initial state of the decoder, skip-connections enhance information flow throughout the decoding process. Further, the mechanism ensures that the decoder has access to a comprehensive representation of the input sequence at each step, facilitating the generation of accurate and contextually rich output sequences. Furthermore, by enabling direct communication between encoder and decoder states, skip-connections mitigate information loss and contribute to the overall effectiveness of Sequence-to-Sequence models.

As described, the input to the Seq2Seq module 250 are the entities and the one or more pretrained process flows. The skip connection allows the underlying Seq2Seq module 250 to identify appropriate steps of pre-trained process flow and create the optimal process flow for new entity, that is the entity to be considered for analyzing the lease document 260.

For example, rent amount per annum for pretrained process flow may contain [“find_amount”, “data_clean”, “find_rent”, “find_tenure”, “calculate_per_annum”]. For new entity, rent amount per annum with increment clause, the chain-flow will create a derivative flow like [“find_amount”, “data_clean”, “find_rent”, “find_tenure”, “find_increment_amount”, “find_increment_period”, “calculate_per_annum_with_increment”]. Hence, the output of the process flow generation module 240 is the process flow for each requirement. In one embodiment of the present disclosure, the output is converted into a vector representation using the same embedding model used for the chunking the lease document 260. The process flow for each requirement (the vector representation) and the entities for analyzing the lease document is fed to the lease abstraction module 255, as shown in FIG. 2.

In one embodiment of the present disclosure, the input to the lease abstraction module 255 is the vector representation process representing each requirement and the entities for analyzing the lease document 260. On receiving the input, the lease abstraction module 255 perform a similarity search in the vector store 235 to retrieve the chunks that are relevant to the entities (representing requirements), wherein the search is performed based on the process flow of the requirements. In one embodiment, the chunks are retrieved by comparing the entity vector with the stored document vectors and identifying the top matches. Then the lease abstraction module 255 utilizes natural language generation methods for generating the summary 270 of the lease document 260. The summary 270 of the lease document 260 is generated in any of the know format for presenting to the user.

As described, a given lease document is processed and parsed to generate text chunks and the chunks are converted into vector chunks. The vector chunks allow efficient similarity search on multilingual lease documents. Further, process flows are generated based on the requirements. In one embodiment, the semantic graph generator identifies entities to be considered for analyzing the lease document and the custom trained Seq2Seq module generates the process flow for each entity. Then, the lease abstraction module uses the generated process flow and the vector chunks of the lease document to abstract the lease document and hence to provide the content of interest to the user. The system and method disclosed in the present disclosure provides information from the lease document responsive to the requirements regardless of format and content of the lease document. Hence the system and method may be used for abstracting any given lease document regardless of languages used, the format and the content of the lease document.

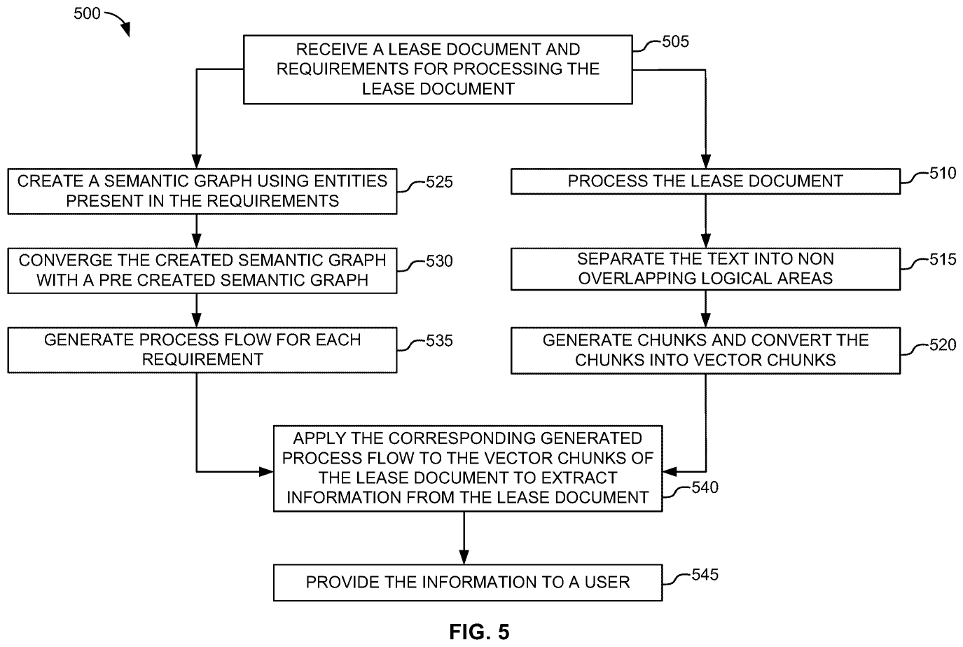

FIG. 5 depicts a flowchart illustrating a method of abstracting a lease document, in accordance with an embodiment of the present disclosure. At step 505, the system 200 receives the lease document 260 and the requirements 265 for processing the lease document. The lease document 260 and the requirements 265 may be inputted to the system 200 through an interface of the system 200 or through an interface of the computing devices 102 and 104. Further, the lease document 260 and the requirements 265 may be in any known format such as but not limited to PDF, word, text file, etc. The requirements 265 may include but not limited to business entities to be extracted from the lease document 260, general entities to be analyzed in the lease document 260 such as start date, renewal date, expiry date, terms and conditions, etc., search keywords, type of expected output (characters, integer, float, etc.) of different entities, or text defining the content to be extracted from the lease document 260. In general, the requirements 265 include but not limited to text defining the information to be extracted from the lease document.

At step 510, the document processing module 205 process the lease document. The processing may include but not limited to Optical Character Recognition (OCR) to covert the content in the lease document 260 into machine readable text, classification of the document by the classification module 210, language translation by the translation module 215 and parsing by the parsing module 220. The parsing by the parsing module 220 may include but not limited to removal of redundant information, error correction, etc. In one embodiment of the present disclosure, the parsing module 220 is further configured for separating the text of the lease document 260 into non-overlapping logical areas, as shown at step 515. For example, the parsing module 220 is configured to extracts the text from the document, identify paragraphs, columns, tables, floating images, headers and footers, sections, subsections, etc. Upon identification, the parsing module 220 removes the images and tables to generate an optimal flow of text for further processing. It is to be noted that the document containing the requirements 265 may also be parsed using the parsing module 220.

At step 520, the chunking module 225 applies predetermined chunk rules to the separated text to generate chunks. In one embodiment of the present disclosure, a custom natural language processing (NLP) model is used for chunking the lease document 260. Chunking includes splitting the text into phrases or segments such as noun phrases, verb phrases or other grammatical structures. In one embodiment, upon separating the text of the lease document 260 into non-overlapping logical areas, the chunking module 225 breaks the text into words or tokens, and then applies one or more chunking rules for generating the chunks of the lease document 260. Further, the LASER embedding module 230 converts the generated chunks of the lease document 260 into vector chunks. That is, the LASER embedding module 230 uses a pretrained language-agnostic sentence representation (LASER) model, trained on a large corpus of text, to encode the text chunks into embeddings. The embeddings are the numerical representations of the text chunks that capture the meaning of the chunks. Each vector represents the meaning of the text chunk in a multi-dimensional space and the dimensions of the vector capture various semantic and syntactic aspects of the text of the lease document 260. The generates vector chunks are stored in the vector store 235.

At step 525, the sematic graph generator 245 generates a semantic graph using the entities present in the requirements. Further, the sematic graph generator 245 converges the created sematic graph with a pre-created sematic graph for identifying the entities to be considered for analyzing the lease document 260.

At step 535, the seq2seq module 250 generates the process flow for each requirement using the entities to be considered for analyzing the lease document 260 and pretrained process flows. As described, the skip connection allows the underlying Seq2Seq module 250 to identify appropriate steps of pre-trained process flow and create the optimal process flow for new entity, that is the entity to be considered for analyzing the lease document 260.

At step 540, the lease abstraction module 255 applies the generated process flows to the vector chunks of the lease document 260 to extract information from the lease document 260. In one embodiment, the lease abstraction module 255 perform a similarity search in the vector store 235 to retrieve the chunks that are relevant to the entities (representing requirements), wherein the search is performed based on the process flow of the requirements. The chunks are retrieved by comparing the entity vector with the stored document vectors and identifying the top matches. Then the lease abstraction module 255 utilizes natural language generation methods for generating the summary of the lease document 260. The summary of the lease document 260 is generated in any of the know format and the summary is presented to the user as shown at step 545.

As described, the system and method disclosed in the present disclosure provides information from the lease document responsive to the requirements regardless of format and content of the lease document. Hence the system and method may be used for abstracting any given lease document regardless of languages used, the format and the content of the lease document. It is to be noted that the proposed system and method may be implemented for abstraction and summarizing any given document with minor modifications or without any modifications. For example, the system and method may be implemented for abstracting a sales agreement, financial reports etc.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in a generic classical processor system and a quantum computing system.

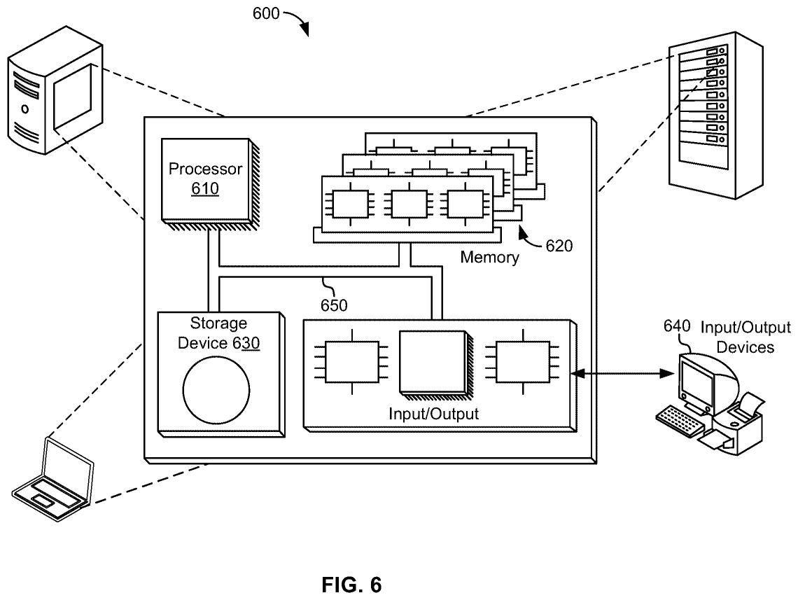

FIG. 6 illustrates a schematic diagram of an exemplary generic classical processor system. The system 600 can be used for the classical operations described in this specification according to some implementations. The system 600 is intended to represent various forms of digital computers, workstations, servers, blade servers, mainframes, and other appropriate computers. The components shown, their connections and relationships, and their functions, are exemplary only, and do not limit implementations of the inventions described and/or claimed in this document. The system 600 includes a processor 610, a memory 620, a storage device 630, and an input/output device 640. Each of the components 610, 620, 630, and 620 are interconnected using a system bus 650. The processor 610 may be enabled for processing instructions for execution within the system 600. In one implementation, the processor 610 is a single-threaded processor. In another implementation, the processor 610 is a multi-threaded processor. The processor 610 may be enabled for processing instructions stored in the memory 620 or on the storage device 630 to display graphical information for a user interface on the input/output device 640. In one implementation, the memory 620 is a computer-readable medium. In one implementation, the memory 620 is a volatile memory unit. In another implementation, the memory 620 is a non-volatile memory unit. The storage device 630 may be enabled for providing mass storage for the system 600. In one implementation, the storage device 630 is a computer-readable medium. In various different implementations, the storage device 630 may be a hard disk device, an optical disk device, or a tape device. The input/output device 640 provides input/output operations for the system 600. In one implementation, the input/output device 640 includes a keyboard and/or pointing device. In another implementation, the input/output device 640 includes a display unit for displaying graphical user interfaces.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A method, comprising:
receiving a lease document and requirements for processing the lease document;
processing the lease document into vector chunks, comprising:
parsing the lease document into text;
separating the text into non-overlapping logical areas;
applying predetermined chunk rules to the separated text to generate chunks;
converting the chunks into vectors chunks;
generating a process flow for each of the requirements, the process flow defining entities to be considered for analyzing the lease document and criteria for analyzing the lease document; and
for each of the requirements, applying the corresponding generated process flow to the vector chunks of the lease document;
wherein the applying provides information from the lease document responsive to the requirements regardless of format and content of the lease document.

2. The method of claim 1, wherein the requirements include text defining the information to be extracted from the lease document, and the criteria defines how to extract the information.

3. The method of claim 2, wherein the information includes start date of the lease, end date of the lease, and/or term of the lease.

4. The method of claim 1, wherein the logical areas comprise header, footer, section heading, subsection heading, and/or paragraph text content.

5. The method of claim 1, wherein the generating the process flow for each of the requirements comprises:
creating a semantic graph using entities present in the requirements;
converging the created semantic graph with a pre-created semantic graph for identifying the entities to be considered for analyzing the lease document; and
generating the process flow for each requirements using the entities to be considered for analyzing the lease document, pretrained process flows and a Sequence-to-Sequency model.

6. A non-transitory computer readable media storing instructions programmed to execute with supporting electronic computer hardware and software to perform operations comprising:
receiving a lease document and requirements for processing the lease document;
processing the lease document into vector chunks, comprising:
parsing the lease document into text;
separating the text into non-overlapping logical areas;
applying predetermined chunk rules to the separated text to generate chunks;
converting the chunks into vectors chunks;
generating, using an AI model, a process flow for each of the requirements, the process flow defining entities and criteria for analyzing the lease document; and
for each of the requirements, applying the corresponding generated process flow to the vector chunks of the lease document;
wherein the applying provides information from the lease document responsive to the requirements regardless of format and content of the lease document.

7. The non-transitory computer readable media of claim 6, wherein the requirements include text defining information to be extracted from the lease document, and the criteria defines how to extract the information.

8. The non-transitory computer readable media of claim 7, wherein the information includes start date of the lease, end date of the lease, and/or term of the lease.

9. The non-transitory computer readable media of claim 6, wherein the logical areas comprise header, footer, section heading, subsection heading, and/or paragraph text content.

10. The non-transitory computer readable media of claim 6, wherein the generating the process flow for each of the requirements comprises:
creating a semantic graph using entities present in the requirements;
converging the created semantic graph with a pre-created semantic graph for identifying the entities to be considered for analyzing the lease document; and
generating the process flow for each requirements using the entities to be considered for analyzing the lease document, pretrained process flows and a Sequence-to-Sequency model.

11. A system comprising:
a processor;
a non-transitory computer readable media storing instructions programmed to cooperate with the processor to perform operations comprising:
receiving a lease document and requirements for processing the lease document;
processing the lease document into vector chunks, comprising:
parsing the lease document into text;
separating the text into non-overlapping logical areas;
applying predetermined chunk rules to the separated text to generate chunks;
converting the chunks into vectors chunks;
generating a process flow for each of the requirements, the process flow defining entities to be considered for analyzing the lease document and criteria for analyzing the lease document; and
for each of the requirements, applying the corresponding generated process flow to the vector chunks of the lease document;
wherein the applying provides information from the lease document responsive to the requirements regardless of format and content of the lease document.

12. The system of claim 11, wherein the requirements include text defining information to be extracted from the lease document, and the criteria defines how to extract the information.

13. The system of claim 11, wherein the logical areas comprise header, footer, section heading, subsection heading, and/or paragraph text content.

14. The system of claim 11, wherein the generating the process flow for each of the requirements comprises:
creating a semantic graph using entities present in the requirements;
converging the created semantic graph with a pre-created semantic graph for identifying the entities to be considered for analyzing the lease document; and
generating the process flow for each requirements using the entities to be considered for analyzing the lease document, pretrained process flows and a Sequence-to-Sequency model.
